(19) United States
(12) Patent Application Publication
(10) Pub. No.: US 2016/0189061 A1
(43) Pub. Date: Jun. 30, 2016

(54) SYSTEM AND METHOD OF EVENT POSITION ALLOCATION

(71) Applicants: Divyesh Jain, Sunnyvale, CA (US); Konstantin Semyonov, Minsk (BY); Rishi Diwan, San Francisco, CA (US); Baskaran Janarthanam, Cupertino, CA (US); John Hack, Maplewood, NJ (US)

(72) Inventors: Divyesh Jain, Sunnyvale, CA (US); Konstantin Semyonov, Minsk (BY); Rishi Diwan, San Francisco, CA (US); Baskaran Janarthanam, Cupertino, CA (US); John Hack, Maplewood, NJ (US)

(21) Appl. No.: 14/586,650

(22) Filed: Dec. 30, 2014

(51) Int. Cl. G06Q 10/02

(52) U.S. Cl. CPC G06Q 10/02

(57) ABSTRACT

In some example embodiments, organizer requests of different organizing-users and comprising corresponding numbers of seats and at least one guest-user can be received for an event. Guest requests of guest-user and comprising corresponding numbers of seats for the event can be received. A plurality of groups and subgroups can be determined based on the number of seats for the organizing-users and guest-users, with each group in the plurality of groups corresponding to a different one of the organizing-users and comprising a corresponding plurality of subgroups. Seats for the event can allocated to the organizing-users and the guest-users based on their corresponding number of seats and an iterative optimization algorithm, with the iterative optimization algorithm being configured to determine an allocation of seats for the event based on calculated distances between seating positions for each group.

### TECHNICAL FIELD

The present application relates generally to the technical field of data processing, and, in various embodiments, to systems and methods of allocating positions (e.g., seats) for an event at a venue.

### BACKGROUND

Attending an event, such as a sports game or a concert, is as much about the social experience as it is about viewing the event. Current solutions for booking tickets for a venue (e.g., a sports stadium or concert venue) involve allocating the seats at the time of the booking of the tickets by the consumer. This approach allows each consumer to get the best possible seats from the viewpoint of viewing the event. However, it leads to fragmentation of the seats, such that if at a later point a big group attempts to book tickets, there are not enough clustered seats available to seat the full group together, which causes the split of the group. Currently, when it comes to allocating seats for an event, there is no technical solution for allowing all the groups of differing sizes to sit together, while still maximizing the occupancy of the event.

### BRIEF DESCRIPTION OF THE DRAWINGS

Some example embodiments of the present disclosure are illustrated by way of example and not limitation in the figures of the accompanying drawings, in which like reference numbers indicate similar elements, and in which:

FIG. 1 is a network diagram illustrating a client-server system, in accordance with some example embodiments;

FIG. 2 is a block diagram illustrating enterprise applications and services in an enterprise application platform, in accordance with some example embodiments;

FIG. 3 is a block diagram illustrating components of a position allocation system, in accordance with some example embodiments;

FIG. 4 is a block diagram illustrating an allocation of positions for an event, in accordance with some example embodiments;

FIG. 5 is a flowchart illustrating a method of position allocation, in accordance with some example embodiments;

FIG. 6 is a flowchart illustrating a method of allocating positions using an iterative optimization algorithm, in accordance with some example embodiments;

FIG. 7 is a block diagram illustrating a mobile device, in accordance with some example embodiments; and

FIG. 8 is a block diagram of an example computer system on which methodologies described herein can be executed, in accordance with some example embodiments.

### DETAILED DESCRIPTION

Example methods and systems of position allocation are disclosed. In the following description, for purposes of explanation, numerous specific details are set forth in order to provide a thorough understanding of example embodiments. It will be evident, however, to one skilled in the art that the present embodiments can be practiced without these specific details.

The present disclosure provides features that enable position allocation for an event at a venue, allowing groups of differing sizes to sit together, while still maximizing the occupancy of the event. The features of the present disclosure also enable other factors of positioning to be considered in position allocation, such as subgroups within a group being positioned together, and groups being allocated positions in an order of priority corresponding to the timing of when they booked their positions. Although a position can comprise and correspond to a single seat, it is contemplated that other types of positions are also within the scope of the present disclosure, including, but not limited to, stalls and other defined areas that can be allocated and assigned to users at the exclusion of other users.

In some example embodiments, a solution comprising two stages is provided. In the first stage, users are enabled to request to be positioned (e.g., seated) in an allocated section as a group. Users within each group can request a number of positions to accommodate them and any guests they may have, and multiple groups can be accommodated using the features of the present disclosure. At this stage, actual positions are not yet assigned to the users. Different groups can request their positions within a predetermined window of time, such as up to a predetermined cutoff time. After the predetermined window of time has expired, the second stage begins, where the position allocation is performed for all of the groups. At this stage, all of the relevant information for the number of groups and the individual group sizes is available so that an optimum position allocation can be achieved, positioning all of the members of the same group together, while also maximizing the occupancy for the event.

The problem of position allocation is a cost optimization problem, which can be solved using a position allocation algorithm that calculates the position distances between the members of a group and the position distances between the members of a subgroup as various costs and aims to minimize the total cost. As such, this problem can be modeled as quadratic programming problem. The simplex method for quadratic programming can be used to solve the problem, applying an iterative solution that picks the minimum cost of all possible solutions at each step and iteratively reduces the cost until it reaches a point where it is no longer possible to reduce the cost. At which point, an optimal solution has been reached.

Current solutions of booking tickets for an event at a venue involve the seats being allocated at the time the user requests the tickets. Although these solutions allow each user to obtain the best possible seats in terms of viewing the event, they lead to fragmentation of the seats. If, at a later point, a group with a large number of member attempts to book tickets for the event, then there may not be enough available seats clustered together to seat the entire group together, thereby causing an undesirable splitting of the group.

The present disclosure provides features that address the fact that, for many people, going to an event is a social experience more than simply the experience of watching the event, and therefore sitting together is as important as obtaining the best seats for viewing the event. The position allocation algorithm and features of the present disclosure provide solutions to optimize both of these considerations. This two level optimization can be achieved by delaying the allocation of positions until all of the booking is completed (e.g., until all of the requests for positions have been received) and all of the necessary information for this optimization has been obtained.

The present disclosure also provides features that enables the formation of subgroups within each group and ensures that, for each subgroup, the members of that subgroup will be positioned together as a cluster (e.g., each member of the subgroup sitting next to at least one other member of the same subgroup). For example, a first user can invite five other users (e.g., five friends) to an event, and each user can have his or her own guests (e.g., spouse, children) that will also be attending the event along with that user. Each user and his or her guests can form a corresponding subgroup within the larger group of all the users and all of their guests. The features of the present disclosure not only allocate positions based on a principle of positioning all of the members a group together in a cluster, but also allocate positions based on a principle of positioning all of the members of a subgroup together in a cluster.

Additionally, group sizes can be difficult to determine precisely, particularly in advance, as there is often uncertainty in terms of interest and availability of potential members of a group in attending an event. The features of the present disclosure enable different group members to request positions (e.g., book seat tickets) for an event at any time during a predetermined time period or until the time period is ended prematurely by some other event, such as all of the positions in a section being allocated and no longer available. This freedom of group members other than the organizer of the group to request, and therefore determine, a corresponding number of positions for their corresponding subgroup alleviates the pressure and avoids the inaccuracy and inefficiency of the organizer of the group having to make a decision about such numbers in advance. Moreover, since each group member can request and purchase his or her own position(s), it relieves the organizer of the burden of having to pay for all of the positions for the entire group and collect money from the other members of the group as reimbursement. The ability of different group members to purchase positions as different times, yet be positioned (e.g., seated) together, is beneficial in providing easier group organization.

Optimal position allocation is a Non-deterministic Polynomial-time hard (NP-Hard) problem, and achieving an optimal position allocation in a reasonable amount time is difficult. By modeling the problem as a quadratic programming problem and then solving it using the iterative optimization algorithm disclosed herein, 100% results (e.g., all groups and subgroups being positioned together according to the previously-discussed principles) consistently in reasonable time (e.g., less than one minute) can be achieved.

In some example embodiments, a plurality of organizer requests is received, via a network, for an event from at least one device, with each organizer request of the plurality of organizer requests corresponding to a different organizing-user and comprising a corresponding number of positions for the corresponding organizing-user and a corresponding identification for each one of at least one guest-user, and the number of positions for each organizing-user representing the organizing-user and at least one guest of the organizing-user. In some example embodiments, a notification is transmitted to each one of the guest-users, with the notification comprising an identification of the event, and the notification being configured to enable the corresponding guest-user to submit a corresponding number of positions for the event. In some example embodiments, a corresponding guest request for each one of the guest-users is received, with each guest request comprising the corresponding number of positions for the event, and with the number of positions for each guest-user representing the guest-user and at least one guest of the guest-user. In some example embodiments, a plurality of groups is determined based on the number of positions for the organizing-users and the number of positions for the guest-users, with each group in the plurality of groups corresponding to a different one of the organizing-users and comprising a corresponding plurality of subgroups, each plurality of subgroups comprising a subgroup for the organizing-user and a corresponding subgroup for each guest-user corresponding to the organizing-user, the subgroup for the organizing-user comprising the organizing-user and the at least one guest of the organizing-user, and the subgroup for each guest-user comprising the guest-user and the at least one guest of the guest-user. In some example embodiments, positions for the event are allocated to the organizing-users and the guest-users based on their corresponding number of positions and an iterative optimization algorithm, with the iterative optimization algorithm being configured to determine an allocation of positions for the event based on calculated distances between positions for each group.

In some example embodiments, it is determined that a predetermined time period for requesting positions has terminated, with the plurality of organizer requests and the plurality of guest requests having been received within the predetermined time period, and an interrupt is generated based on the determining that the predetermined time period has terminated, wherein the allocating is performed based on the generated interrupt.

In some example embodiments, the iterative optimization algorithm is further configured to determine the allocation based on a preference to minimize a distance between subgroups of a same group. In some example embodiments, the iterative optimization algorithm is further configured to determine the allocation based on a preference to minimize a distance between members of a same subgroup, the members comprising any of the organizing-users, guest-users, and guests of the same subgroup.

In some example embodiments, the iterative optimization algorithm is further configured to determine the allocation based on a preference to configure members of a same subgroup in a line configuration in a same row based on a first determination that the same subgroup satisfies a first predetermined condition for number of members, and to configure members of the same subgroup in a block configuration in different rows based on a second determination that the same subgroup satisfies a second predetermined condition for number of members, the members comprising any of the organizing-users, guest-users, and guests of the same subgroup.

In some example embodiments, the iterative optimization algorithm comprises a Monte Carlo method. In some example embodiments, the iterative optimization algorithm comprises: determining a current allocation of positions to members of each one of the plurality of groups for the event, the members comprising the organizing-users, guest-users, and guests of the plurality of groups; determining if a potential change to the current allocation will reduce a distance cost of the current allocation, the potential change comprising switching a position allocation of two of the members; in response to a determination that the potential change will reduce the distance cost, changing the current allocation based on the potential change; in response to a determination that the potential change will not reduce the distance cost, determining a local optimal allocation to be the current allocation; randomly determining a new allocation of positions to members of the each one of the plurality of groups for the event; initializing the current allocation to be equal to the new allocation; repeating the determining the current allocation, the determining if the potential change, the changing the current allocation, and the determining the local optimal allocation based on the initialized current allocation; and determining a best local optimal allocation amongst multiple local optimal allocations based on a comparison of respective distance costs for the multiple local optimal allocations.

In some example embodiments, transmitting the notification to each one of the guest-users comprises at least one of transmitting an e-mail comprising the notification, transmitting a text message comprising the notification, and causing a page comprising the notification to be displayed within an application on a computing device.

The methods or embodiments disclosed herein may be implemented as a computer system having one or more modules (e.g., hardware modules or software modules). Such modules may be executed by one or more processors of the computer system. In some example embodiments, a non-transitory machine-readable storage device can store a set of instructions that, when executed by at least one processor, causes the at least one processor to perform the operations and method steps discussed within the present disclosure.

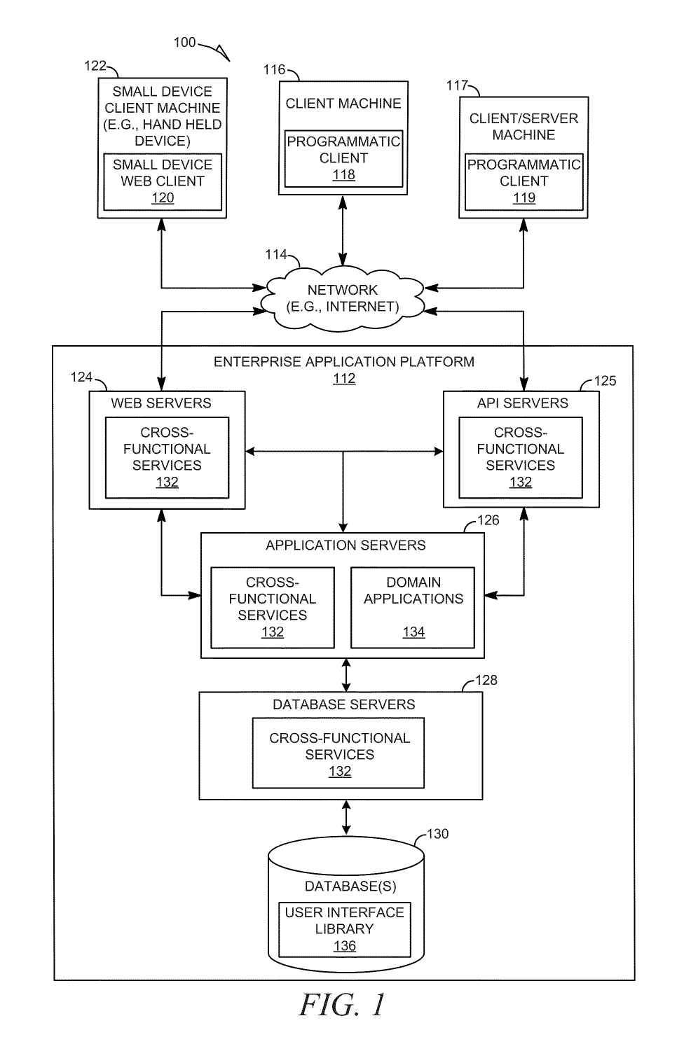

FIG. 1 is a network diagram illustrating a client-server system 100, in accordance with some example embodiments. A platform (e.g., machines and software), in the example form of an enterprise application platform 112, provides server-side functionality, via a network 114 (e.g., the Internet) to one or more clients. FIG. 1 illustrates, for example, a client machine 116 with programmatic client 118 (e.g., a browser), a small device client machine 122 with a small device web client 120 (e.g., a browser without a script engine), and a client/server machine 117 with a programmatic client 119.

Turning specifically to the example enterprise application platform 112, web servers 124 and Application Program Interface (API) servers 125 can be coupled to, and provide web and programmatic interfaces to, application servers 126. The application servers 126 can be, in turn, coupled to one or more database servers 128 that facilitate access to one or more databases 130. The cross-functional services 132 can include relational database modules to provide support services for access to the database(s) 130, which includes a user interface library 136. The web servers 124, API servers 125, application servers 126, and database servers 128 can host cross-functional services 132. The application servers 126 can further host domain applications 134.

The cross-functional services 132 provide services to users and processes that utilize the enterprise application platform 112. For instance, the cross-functional services 132 can provide portal services (e.g., web services), database services and connectivity to the domain applications 134 for users that operate the client machine 116, the client/server machine 117 and the small device client machine 122. In addition, the cross-functional services 132 can provide an environment for delivering enhancements to existing applications and for integrating third-party and legacy applications with existing cross-functional services 132 and domain applications 134. Further, while the system 100 shown in FIG. 1 employs a client-server architecture, the embodiments of the present disclosure are of course not limited to such an architecture, and could equally well find application in a distributed, or peer-to-peer, architecture system.

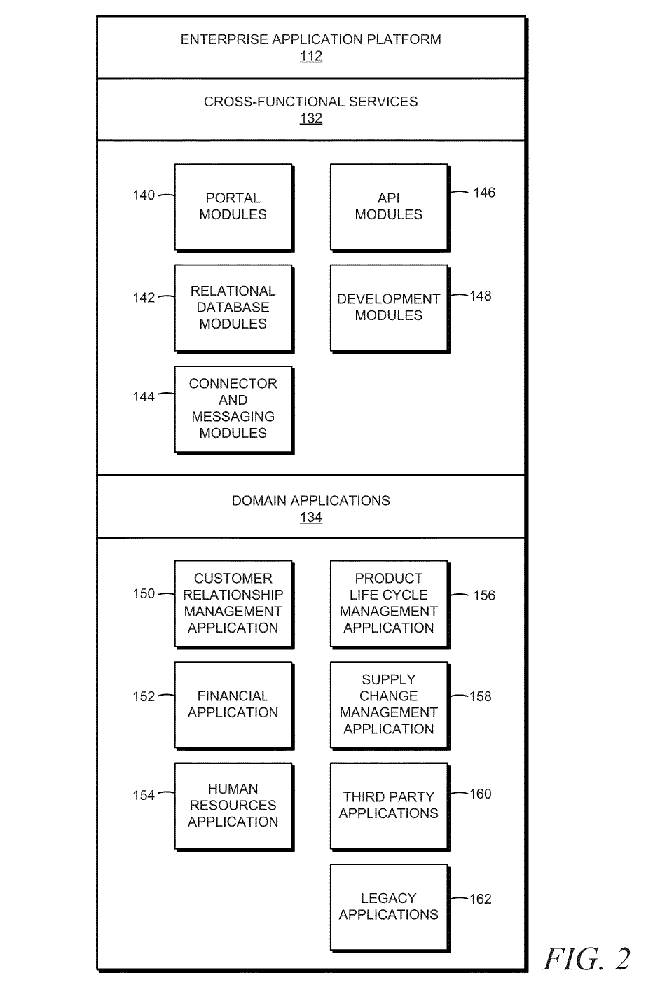

The enterprise application platform 112 can implement partition level operation with concurrent activities. For example, the enterprise application platform 112 can implement a partition level lock, a schema lock mechanism, manage activity logs for concurrent activity, generate and maintain statistics at the partition level, and efficiently build global indexes. The enterprise application platform 112 is described in greater detail below in conjunction with FIG. 2.

FIG. 2 is a block diagram illustrating enterprise applications and services in an enterprise application platform 112, in accordance with an example embodiment. The enterprise application platform 112 can include cross-functional services 132 and domain applications 134. The cross-functional services 132 can include portal modules 140, relational database modules 142, connector and messaging modules 144, API modules 146, and development modules 148.

The portal modules 140 can enable a single point of access to other cross-functional services 132 and domain applications 134 for the client machine 116, the small device client machine 122, and the client/server machine 117. The portal modules 140 can be utilized to process, author and maintain web pages that present content (e.g., user interface elements and navigational controls) to the user. In addition, the portal modules 140 can enable user roles, a construct that associates a role with a specialized environment that is utilized by a user to execute tasks, utilize services and exchange information with other users and within a defined scope. For example, the role can determine the content that is available to the user and the activities that the user can perform. The portal modules 140 include a generation module, a communication module, a receiving module and a regenerating module. In addition the portal modules 140 can comply with web services standards and/or utilize a variety of Internet technologies including Java, J2EE, SAP's Advanced Business Application Programming Language (ABAP) and Web Dynpro, XML, JCA, JAAS, X.509, LDAP, WSDL, WSRR, SOAP, UDDI and Microsoft .NET.

The relational database modules 142 can provide support services for access to the database(s) 130, which includes a user interface library 136. The relational database modules 142 can provide support for object relational mapping, database independence and distributed computing. The relational database modules 142 can be utilized to add, delete, update and manage database elements. In addition, the relational database modules 142 can comply with database standards and/or utilize a variety of database technologies including SQL, SQLDBC, Oracle, MySQL, Unicode, JDBC, or the like.

The connector and messaging modules 144 can enable communication across different types of messaging systems that are utilized by the cross-functional services 132 and the domain applications 134 by providing a common messaging application processing interface. The connector and messaging modules 144 can enable asynchronous communication on the enterprise application platform 112.

The API modules 146 can enable the development of service-based applications by exposing an interface to existing and new applications as services. Repositories can be included in the platform as a central place to find available services when building applications.

The development modules 148 can provide a development environment for the addition, integration, updating and extension of software components on the enterprise application platform 112 without impacting existing cross-functional services 132 and domain applications 134.

Turning to the domain applications 134, the customer relationship management application 150 can enable access to and can facilitate collecting and storing of relevant personalized information from multiple data sources and business processes. Enterprise personnel that are tasked with developing a buyer into a long-term customer can utilize the customer relationship management applications 150 to provide assistance to the buyer throughout a customer engagement cycle.

Enterprise personnel can utilize the financial applications 152 and business processes to track and control financial transactions within the enterprise application platform 112. The financial applications 152 can facilitate the execution of operational, analytical and collaborative tasks that are associated with financial management. Specifically, the financial applications 152 can enable the performance of tasks related to financial accountability, planning, forecasting, and managing the cost of finance.

The human resource applications 154 can be utilized by enterprise personnel and business processes to manage, deploy, and track enterprise personnel. Specifically, the human resource applications 154 can enable the analysis of human resource issues and facilitate human resource decisions based on real time information.

The product life cycle management applications 156 can enable the management of a product throughout the life cycle of the product. For example, the product life cycle management applications 156 can enable collaborative engineering, custom product development, project management, asset management and quality management among business partners.

The supply chain management applications 158 can enable monitoring of performances that are observed in supply chains. The supply chain management applications 158 can facilitate adherence to production plans and on-time delivery of products and services.

Customer relationship management (CRM) applications (not shown) can enable management of an organization's interactions with customers, providing solutions for organizing, automating, and synchronizing such activities, such as the booking and allocation features disclosed herein.

The third-party applications 160, as well as legacy applications 162, can be integrated with domain applications 134 and utilize cross-functional services 132 on the enterprise application platform 112.

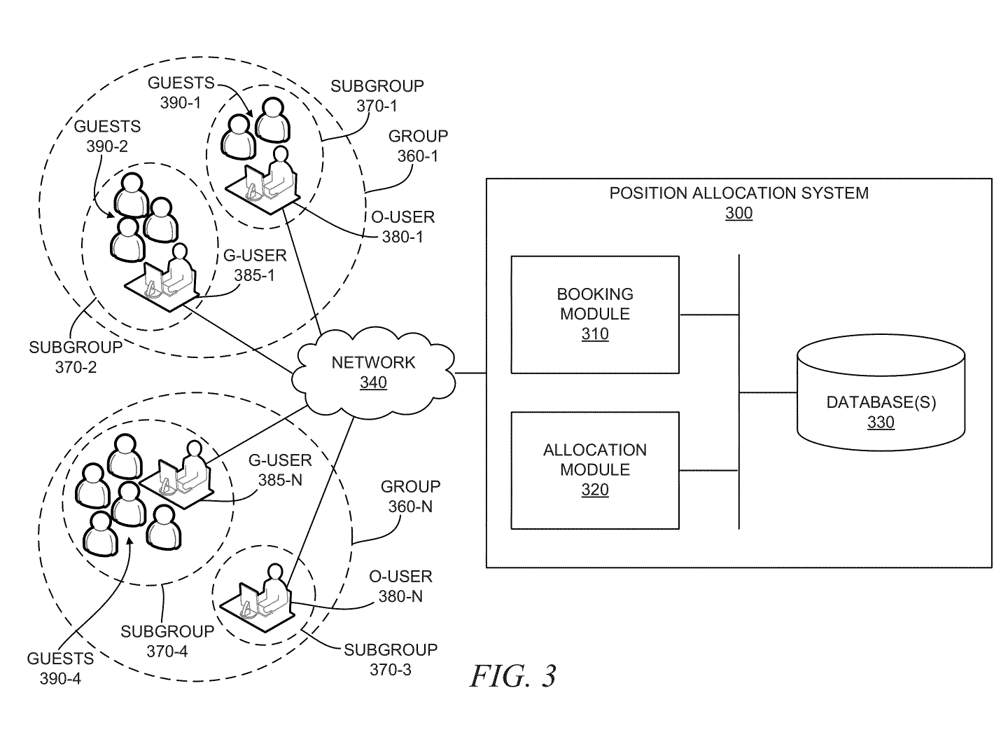

FIG. 3 is a block diagram illustrating components of a position allocation system 300, in accordance with some example embodiments. In some example embodiments, the position allocation system 300 comprises any combination of one or more of a booking module 310, an allocation module 320, and one or more databases 330. The modules 310 and 320 and the database(s) 330 can reside on a machine having a memory and at least one processor (not shown). In some example embodiments, the modules 310 and 320 and the database(s) 330 can be incorporated into the enterprise application platform 112 in FIG. 1 (e.g., on application server(s) 126). However, it is contemplated that other configurations are also within the scope of the present disclosure.

In some example embodiments, the booking module 310 is configured to receive a plurality of organizer requests for an event. The organizer requests can be based on and correspond to input provided by one or more organizing-users 380 (e.g., O-USERS 380-1 to 380-N in FIG. 3). The organizer requests can originate and be sent directly from the organizing-users 380, via corresponding devices (e.g., desktop computer, laptop computer, tablet computer, smartphone) of the organizing-users 380, to the position allocation system 300 or they can be generated by at least one computing device within the position allocation system 300 based on the input submitted by the organizing-users 380. The booking module 310 can enable the organizing-users to submit the input in a variety of different ways, including, but not limited to, via a user interface of a web page, via a user interface of a mobile application, via an e-mail message, or via a text message.

Each organizer request can correspond to a different organizing-user 380 (e.g., one organizer request for one organizing-user 380 and another organizer request for another organizing-user 380). Furthermore, each organizer request can comprise a corresponding number of positions for the corresponding organizing-user 380, as well as a corresponding identification for each one of at least one guest-user (e.g., G-USER 385-1 TO 385-N in FIG. 3). The number of positions for each organizing-user 380 represents the number of positions being requested by the organizing-user 380 to accommodate the organizing-user 380 and any guests 390 of the organizing-user 380. The guests 390 of an organizing-user 380 can exclude any guest-users 385 that the organizing-user 380 has identified. For example, in the embodiment shown in FIG. 3, since organizing-user 380-1 has two guests 390-1, the corresponding number of positions for the organizer request of organizing-user 380-1 would be three, in order to accommodate the organizing-user 380-1 and the two guests 390-1.

As previously discussed, a position can comprise and correspond to a single seat. However, it is contemplated that other types of positions are also within the scope of the present disclosure, including, but not limited to, stalls and other defined areas at an event venue that can be allocated and assigned to users at the exclusion of other users.

In some example embodiments, the booking module 310 is further configured to transmit a notification to each one of the guest-users 385 identified in the organizer-request. For example, in the embodiments shown in FIG. 3, the organizer request corresponding to organizing-user 380-1 comprises an identification of guest-user 385-1. Therefore, a notification can be transmitted to guest-user 385-1. The notification can comprise an identification of the event and be configured to enable the corresponding guest-user 385 to submit a corresponding number of positions for the event. Similar to the corresponding numbers of positions for the organizing-users 380 discussed above, the corresponding number of positions for each guest-user 385 can represent the number of positions being requested by the guest-user 385 to accommodate the guest-user 385 and any guests 390 of the guest-user 385. The guests 390 of a guest-user 385 can exclude any organizing-users 380 that have identified the guest-user 385. For example, in the embodiment shown in FIG. 3, since guest-user 385-1 has three guests 390-2, the corresponding number of positions for the organizer request of guest-user 385-1 would be four, in order to accommodate the guest-user 385-1 and the three guests 390-2.

The notification can be transmitted to each one of the guest-users 385 via a variety of ways, including, but not limited to, transmitting an e-mail comprising the notification, transmitting a text message comprising the notification, and causing a page comprising the notification to be displayed within an application on a computing device.

The booking module 310 can receive, from each one of the guest-users 385, a guest request comprising the corresponding number of positions of the guest-user 385 for the event. The booking module 310 can enable the organizing-users to submit the input for the guest request in a variety of different ways, including, but not limited to, via a user interface of a web page, via a user interface of a mobile application, via an e-mail message, or via a text message.

The communication (e.g., transmission) of data between systems, modules, databases, users, and devices disclosed herein can be achieved via communication over a network. Accordingly, the position allocation system 300 can be part of a network-based system. The network may be any network that enables communication between or among machines, databases, and devices. Accordingly, the network may be a wired network, a wireless network (e.g., a mobile or cellular network), or any suitable combination thereof. The network may include one or more portions that constitute a private network, a public network (e.g., the Internet), or any suitable combination thereof.

Similar to the organizer requests, the guest requests can originate and be sent directly from the guest-users 385, via corresponding devices (e.g., desktop computer, laptop computer, tablet computer, smartphone) of the guest-users 385, to the position allocation system 300 or they can be generated by at least one computing device within the position allocation system 300 based on the input submitted by the guest-users 385.

In some example embodiments, an organizer request of an organizing-user 380 can exclude any identification of any guest-users 390. Additionally, the corresponding number of positions of an organizer request for an organizing-user 380 can be one, indicating that the organizing-user 380 does not plan to have any of his or her own guests 390 at the event. For example, in the embodiments shown in FIG. 3, the corresponding number of positions of the organizer request for organizing-user 380-N is one, since the organizing-user 380-N does not have any guests 380. At the same time, the organizing-user 380-N in this example has provided input to identify guest-user 385-N in the organizer request, and guest-user 385-N has submitted input to indicate that the corresponding number of positions for guest-user 385-N is six, since guest-user 385-N has five guests 390-4. It is contemplated that other configurations of organizer requests and guest requests in terms of the number of positions are also within the scope of the present disclosure.

In some example embodiments, the booking module 310 is further configured to determine one or more groups 360 (e.g., GROUPS 360-1 TO 360-N in FIG. 3) based on the number of positions for the organizing-users 380 and the number of positions for the guest-users 385. Each group 360 can correspond to a different one of the organizing-users 380. For example, in the embodiment shown in FIG. 3, group 360-1 corresponds to organizing-user 380-1, and group 360-N corresponds to organizing-user 380-N. Each group 360 can be initiated based on the organizer request and then completed based on any guest requests, as the final number of positions being requested can be totaled once all of the guest requests, if any, have been received.

Each group 360 can comprise corresponding subgroups 370. Each group 360 can comprise a subgroup 370 for the organizing-user 380 and a corresponding subgroup 370 for each guest-user 385 corresponding to the organizing-user 380. The subgroup 370 for the organizing-user 380 can comprise the organizing-user 380 and any guests 390 of the organizing-user 380, and the subgroup 370 for each guest-user 385 can comprise the guest-user 385 and any guests 390 of the guest-user 385. For example, in the embodiment shown in FIG. 3, group 360-1 comprises subgroup 370-1, which comprises organizing-user 380-1 and guests 390-1, and subgroup 370-2, which comprises guest-user 385-1 and guests 390-2, while group 360-N comprises subgroup 370-3, which comprises only organizing-user 380-N, and subgroup 370-4, which comprises guest-user 385-N and guests 390-4. It is contemplated that other group and subgroup configurations are also within the scope of the present disclosure.

In some example embodiments, the allocation module 320 is configured to allocate positions for the event to the organizing-users 380 and the guest-users 385 based on an iterative optimization algorithm that uses the numbers of positions, as well as the determined groups and subgroups. The iterative optimization algorithm can be configured to determine an allocation of positions for the event based on calculated distances between positions for each group, which will be discussed in further detail below.

All of the information discussed above, such as the information included in the organizer requests, the information included in the guest requests, details of the groups, and the details of the subgroups, can be stored in the database(s) 330 for subsequent retrieval and use.

In some example embodiments, the position allocation system 300 establishes and enforces a predetermined time period within which organizing-users 380 and guest-users 385 can successfully request that their provided input be included in the allocation of positions. For example, organizing-users 380 and guest-users 385 can submit their corresponding requests during a predetermined window of time. During this predetermined window of time, the booking module 310 can continue to receive and process the information of the requests. The position allocation system 300 can determine when the predetermined window of time expires. This determination can be made by the booking module 310 or the allocation module 320, or some other component of the position allocation system 300. An interrupt can be generated based on this determination that the predetermined time period has expired. This generated interrupt can be used to cause the allocation module 320 to include only the information corresponding to the organizer requests and the guest requests received within the predetermined time period in the allocation of positions for the event. For example, the booking module 310 can simply stop accepting organizer-request and guest-requests after the termination of the predetermined time period. In another example, the allocation module 320 can be configured to perform the allocation of positions in response to the indication that the predetermined time period has ended (e.g., in response to the generated interrupt), thus beginning the allocation of positions before any subsequent organizer requests or guest requests submitted after the expiration of the predetermined time period have been received. Other configurations of enforcing the predetermined time period are also within the scope of the present disclosure.

In some example embodiments, the position allocation system 300 can additionally or alternatively implement an availability time period within which organizing-users 380 and guest-users 385 can successfully request that their provided input be included in the allocation of positions, where the availability time period is based on the availability of positions. For example, the booking module 310 can simply stop accepting or processing organizer-requests and guest-requests for positions in a section of a venue in response to a determination that there are no more available positions in that section (e.g., there are only 50 positions in section D and all 50 positions in section D have already been requested at the time a user wants to request 4 positions in section D). This availability time period independent of the predetermined time period discussed above, but can act to terminate that predetermined time period prematurely, such as if all positions in a section are requested before the predetermined time period has passed. For example, if the predetermined time period for requesting positions is scheduled to terminate on Dec. 23, 2014, but all of the positions in a section have already been requested by Dec. 20, 2014, then the predetermined time period may be terminated early, no more requests for that section are accepted, and the allocation of the positions for that section can be triggered or otherwise performed based on the determination that all of the positions for that section have been requested.

As previously mentioned, the iterative optimization algorithm can be configured to determine the allocation of positions for the event based on calculated distances between positions for each group 360. In some example embodiments, the iterative optimization algorithm is configured to determine the allocation based on a preference to minimize a distance between subgroups 370 of the same group 360. In some example embodiments, the iterative optimization algorithm is configured to determine the allocation based on a preference to minimize a distance between members of the same subgroup 370.

The members of a group 360 and the members of a subgroup 370 can comprise any of the organizing-users 380, guest-users 385, and guests 390. For example, in the embodiment shown in FIG. 3, the members of group 360-1 include organizing-user 380-1, guests 390-1, guest-user 385-1, and guests 390-2, while the members of subgroup 370-1 include only organizing-user 380-1 and guests 390-1.

In some example embodiments, the iterative optimization algorithm is configured to determine the allocation based on a preference to configure members of the same subgroup 370 in a line configuration in the same row based on a first determination that the same subgroup satisfies a first predetermined condition for number of members, such as that the number of members in the subgroup 370 is within a predetermined range (e.g., 2 to 5 members), and a preference to configure members of the same subgroup 370 in a block configuration in different rows based on a second determination that the same subgroup satisfies a second predetermined condition for number of members, such as that the number of members in the subgroup 370 is above a predetermined number (e.g., more than 5 members).

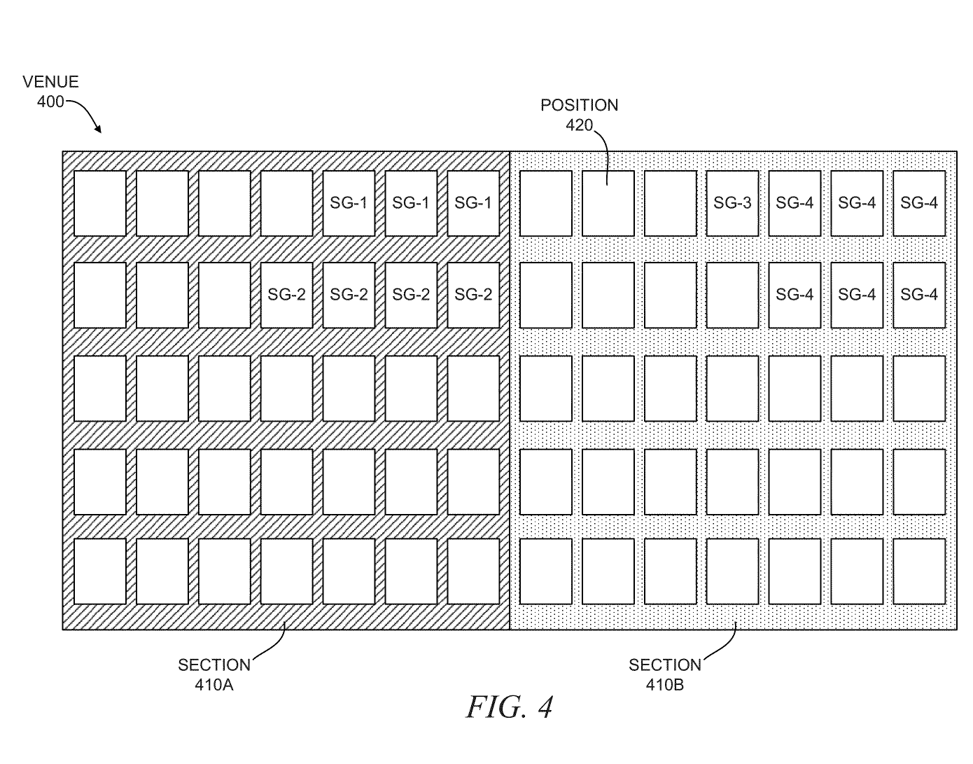

FIG. 4 is a block diagram illustrating an allocation of positions for an event at a venue 400, in accordance with some example embodiments. The venue can comprise a plurality of different sections, such as section 410A and section 410B. Each section comprises a plurality of positions 420 that can be allocated to members. In some example embodiments, organizing-users 380 can be enabled to select, or otherwise indicate, a specific section or group of sections. Such an indication can comprise an explicit selection of a specific section or group of sections, but can also comprise an explicit selection of a price or price range the organizing-user 380 wants to be used in determining the available positions for allocation, which can be used to determine the appropriate section or sections for the organizing-user 380 and members of his or her group 360 (e.g., selection of $25-$50 price range can correspond to section 410B).

In this example embodiment shown in FIG. 4, the allocation based on the preferences discussed above can be seen. The example allocation shown can be based on the members shown in FIG. 3. Accordingly, the members of group 360-1 can be allocated positions 420 in section 410A. Since the allocation module 320 can allocate positions in accordance with the principles that members of the same group 360 should be positioned as closely together as possible and members of the same subgroup 370 should be positioned as closely together as possible, the allocation module 320 can configure the allocation such that the members of subgroup 370-1 (organizing-user 380-1 and guests 390-1 from FIG. 3) are allocated positions 420 next to each other in the same row, which is shown by 3 positions in the first row being allocated to the members of subgroup 370-1 of group 360-1, who are represented by the labels SG-1. Additionally, the members of subgroup 370-2 (organizing-user 385 and guests 390-2 from FIG. 3) are allocated positions 420 next to each other in the same row behind the row of the members of subgroup 370-1, which is shown by 4 positions 420 in the second row being allocated to the members of subgroup 370-2 of group 360-1, who are represented by the labels SG-2.

It is contemplated that, in this example embodiment of FIG. 4, the allocation module 320 can be enforcing a preference that subgroups 370 having 2-5 members are to be allocated positions 420 in a line configuration in the same row, whereas subgroups having more than 5 members are allocated positions 420 in a block configuration across multiple adjacent rows. Additionally, the allocation module 320 can be enforcing a preference that subgroups 370 of the same group 360 are to be allocated positions 420 as close to each other as possible (e.g., adjacent one another), thereby leading to subgroup 370-1 and subgroup 370-2 being allocated positions next to one another.

Additionally, the one member of subgroup 370-3 (organizing-user 380-N from FIG. 3) is allocated position 420 in section 410B next to subgroup 370-4, since they belong to the same group 360-N. This allocation is shown in FIG. 4 by 1 position 420 in the first row being allocated to the 1 member of subgroup 370-3 of group 360-N, who is represented by the label SG-3, and 6 positions 420 across the first and second rows being allocated to the 6 members of subgroup 370-4, who are represented by the labels SG-4. The allocation module 320 can allocate the positions 420 across multiple rows to the members of subgroup 370-4 based on a preference that subgroups 370 having more than 5 members are to be allocated positions 420 in a block configuration across multiple adjacent rows. Since subgroup 370-4 has 6 members, the allocation module 420 can allocate the positons 420 to those members across 2 rows in accordance with the above-mentioned preference. Additionally, the allocation module 320 can be enforcing a preference that subgroups 370 of the same group 360 are to be allocated positions 420 as close to each other as possible (e.g., adjacent one another), thereby leading to subgroup 370-3 and subgroup 370-4 being allocated positions next to one another.

It is contemplated that the example embodiment of FIG. 4 is merely provided as a simple example for convenience of understanding the principles and preferences discussed above. Other configurations are also within the scope of the present disclosure.

Some example embodiments of the iterative optimization algorithm employed by the allocation module 320 will now be discussed in further detail. A section of a venue for which the position allocation is to be determined can comprise m positions, and there can be n groups with pᵢ members in each group Σ_{i=1 . . . n}pᵢ≦m. As previously discussed, the iterative optimization algorithm can allocate positions to members of groups 360 and subgroups 370 based on certain principles, preferences, or conditions, including, but not limited to, members of the same subgroup 370 being allocated positions as close to each other as possible, subgroups 370 of the same group 360 being allocated positions as close to each other as possible, groups 360 or subgroups 370 having within a predetermined range of members being allocated positions in a line configuration in the same row, and groups 360 or subgroups 370 having above the predetermined range of members being allocated positions in a block configuration spanning across multiple rows.

The iterative optimization algorithm can calculate total distance costs for different possible allocations In some example embodiments, the iterative optimization algorithm can calculate a geometrical distance:

d_{j,k}=2\sqrt{(rⱼ−rₖ)²+(cⱼ−cₖ)²},

where rᵢ is the row coordinate of position i, cᵢ is the column coordinate of position i, and d_{j,k} is the distance between positions j and k.

The condition that members of the same group 360 are to be allocated positions as close to each other as possible can be expressed as:

Σᵢ₌1 . . . n(Σ_{j=1 . . . m-1}Σ_{k=j . . . m}d_{j,k}y_{i,j}y_{i,k})→min,

Where y_{i,j} is equal to 1 if position j is allocated to group i, and y_{i,j} is otherwise equal to 0.

The mathematical statement of the allocation problem can be expressed as:

$${x}^{′} Dx \to min , \\ Ax - b = 0 , \\ x \geq 0 , \\ where \text{:}$$

$$D is ( {n}^{*} m ) \times ( {n}^{ *} m ) matrix [ \begin{matrix}R & 0 & 0 \\ 0 & ⋱ & 0 \\ 0 & 0 & R\end{matrix} ] , \\ R is m \times m matrix [ \begin{matrix}{d}_{j , k} & j = 1 … m \\ k = 1 … m & ⋱\end{matrix} ] , \\ A is ( m + n ) \times ( {m}^{*} n ) matrix [ \begin{matrix}F \\ G\end{matrix} ] ,$$

F is m×(m*n) matrix [Iₘ, . . . , Iₘ|n times], Iₘ is the identity matrix,
G is n×(m*n) matrix [L₁, . . . , Lₘ], where Lᵢ is n×n matrix where row j is filled with 1, and

$$B is ( m + n ) vector [ \begin{matrix}1 \\ ⋮ \\ 1 \\ {p}_{1} \\ ⋮ \\ {p}_{n}\end{matrix} ] .$$

Accordingly, a problem of quadratic programming is presented, which can be solved using the gradient method for quadratic programming.

The realization of the iterative optimization algorithm can be based on an iteration process of reducing the cost of allowable allocation. The term “allowable” refers to allocations that are both possible and adhere to the principles, preferences, or conditions previously discussed. During an initial phase, the allocation module 320 can find a first allowable allocation of positions. The allocation module 320 can then find the change of the allocation that has the largest reduction of the distance cost, such as by choosing the largest projection of the gradient on the set of feasible changes. The set of available changes that can be used is switching positions for 2 members. If the allocation module 320 finds an allocation that will reduce the distance cost, then it changes the allocation and repeats the step of finding another change of the allocation based on the new allocation resulting from the previous change. If there is no new allocation that will reduce the distance cost, then the allocation module 320 determines that it has found the local optimal allocation.

Unfortunately, there are no mathematical criteria for ensuring that the local optimal allocation is a global optimal allocation. Therefore, the allocation module 320 can immerse the local optimal allocation algorithm in a probabilistic Monte-Carlo algorithm. Accordingly, a local optimal allocation can be determined, as described above. This local optimal allocation can be stored in the database(s) 330 for subsequent retrieval and use.

The allocation randomly determining a new allocation of seats module 320 can then perform a random shake, and then finding a new local optimal allocation (as described above) based on the new allowable allocation being used as the first allowable allocation. The allocation module can compare two local optimal allocations and select the one having the smaller distance cost as the local optimal allocation to store for subsequent comparison and possible implementation as the final allocation. These steps can be repeated several times to increase the probability of finding the best optimal allocation.

The realization of the algorithm can employ in-memory data storage and parallel computing. The calculation of the distances can be based on coordinates stored for each position. In order to satisfy the previously discussed preferences, principles, and conditions (e.g., members of the same subgroup being allocated positions in the same row), affine transformation with a coefficient K can be used for long distances between rows. This coefficient K can be used in the calculation of distances to account for different position configurations in the venue. For example, sometimes seats in a stadium are not configured in a purely rectangular configuration. The seats can be configured in other shapes as well, including, but not limited to, round and triangular. Additionally, in some situations, the actual distances between positions may not be accurately reflected by the calculations. Therefore, the coefficient K can be used in a transformation to adjust for these situations. In an initial phase, the allocation module 320 can generate the first available allocation of positions and save it in tables stored in the database(s) 330. The allocation module 320 can calculate the appropriate coefficients of groups and subgroups, and these coefficients can then be used for the calculation of distances.

The iterative optimization algorithm can iterate until a predetermined condition is met. In some example embodiments, the algorithm can iterate until the number of random shakes performed is equal to a certain percentage more than the total number of positions available for allocation (e.g., more than 10,000% of the number of positions). In some example embodiments, the algorithm can iterate until a timestamp is determined to indicate that the total execution time of the algorithm is more than expected. Other predetermined conditions are also within the scope of the present disclosure. The algorithm can return the current optimal allocation as the official allocation based on the termination of the iteration.

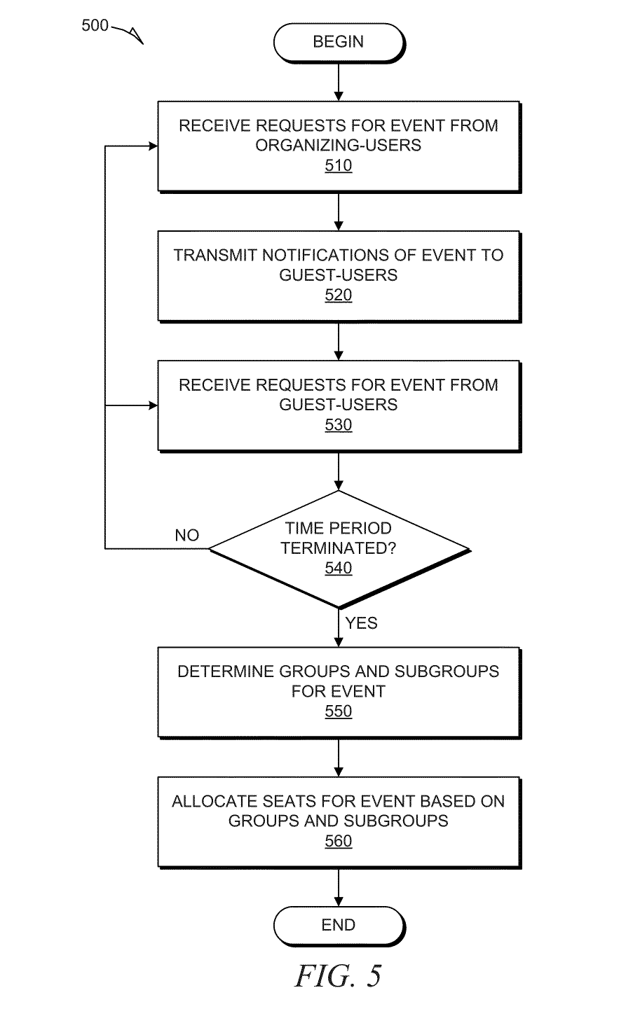

FIG. 5 is a flowchart illustrating a method 500 of position allocation, in accordance with some example embodiments. Method 500 can be performed by processing logic that can comprise hardware (e.g., circuitry, dedicated logic, programmable logic, microcode, etc.), software (e.g., instructions run on a processing device), or a combination thereof. In one example embodiment, the method 500 is performed by the position allocation system 300 of FIG. 3, or any combination of one or more of its components or modules, as described above.

At operation 510, a plurality of organizer requests can be received for an event, with each organizer request of the plurality of organizer requests corresponding to a different organizing-user and comprising a corresponding number of seats for the corresponding organizing-user and a corresponding identification for each one of at least one guest-user. The number of seats for each organizing-user can represent the organizing-user and at least one guest of the organizing-user.

At operation 520, a notification can be transmitted to each one of the guest-users, with the notification comprising an identification of the event, and the notification being configured to enable the corresponding guest-user to submit a corresponding number of seats for the event.

At operation 530, a guest request comprising the corresponding number of seats for the event can be received from each one of the guest-users, with the number of seats for each guest-user representing the guest-user and at least one guest of the guest-user.

At operation 540, it can be determined whether or not a predetermined time period for requests for the event has terminated. If it is determined that the predetermined time period has not terminated, then requests can continue to be received at operation 510 and/or at operation 530. If it is determined that the predetermined time period has terminated, then the method 500 can proceed to operation 550.

At operation 550, a plurality of groups can be determined based on the number of seats for the organizing-users and the number of seats for the guest-users, with each group in the plurality of groups corresponding to a different one of the organizing-users and comprising a corresponding plurality of subgroups. Each plurality of subgroups can comprise a subgroup for the organizing-user and a corresponding subgroup for each guest-user corresponding to the organizing-user. The subgroup for each organizing-user can comprise the organizing-user and the guest(s) of the organizing-user, and the subgroup for each guest-user can comprise the guest-user and the guest(s) of the guest-user.

At operation 560, seats for the event can be allocated to the organizing-users and the guest-users based on their corresponding number of seats and an iterative optimization algorithm. As previously discussed, the iterative optimization algorithm can be configured to determine an allocation of seats for the event based on calculated distances between positions for each group. The final allocation determined by the iterative optimization algorithm can be stored and used by the position allocation system 300 for further processing, such as sending confirmation messages to the user informing them of the specific positions that they have been allocated.

It is contemplated that any of the other features described within the present disclosure can be incorporated into method 500.

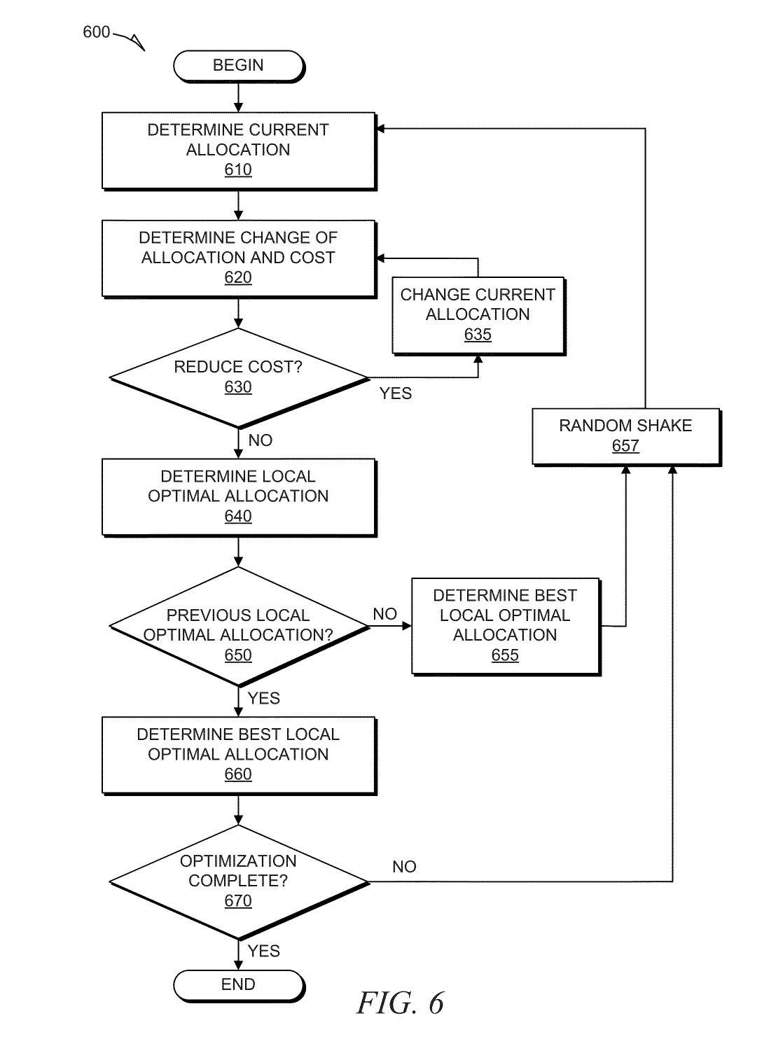

FIG. 6 is a flowchart illustrating a method 600 of allocating positions using an iterative optimization algorithm, in accordance with some example embodiments. Method 600 can be performed by processing logic that can comprise hardware (e.g., circuitry, dedicated logic, programmable logic, microcode, etc.), software (e.g., instructions run on a processing device), or a combination thereof. In one example embodiment, the method 600 is performed by the position allocation system 300 of FIG. 3, or any combination of one or more of its components or modules, as described above.

At operation 610, a current allocation of positions for an event is determined. At this initial stage, a first allowable allocation is determined and used as the current allocation.

At operation 620, a change of the current allocation is determined, along with the associated distance cost of the change.

At operation 630, it is determined whether or not the determined change of the current allocation reduces the distance cost (e.g., whether the distance cost of a new allocation based on the change is less than the distance cost of the current allocation). If it is determined that the change of the current allocation would reduce the distance cost, then the method 600 proceeds to operation 635, where the current allocation is changed based on the determined change of operation 620. The method 600 then returns to operation 620, where another change in the current allocation (now incorporating the previous change) is determined.

If, at operation 630, it is determined that the change of the current allocation would not reduce the distance cost, then the method 600 proceeds to operation 640, where the current allocation is determined to be the local optimal allocation.

At operation 650, it is determined whether or not there has been a previous determination of a local optimal allocation with which the most recent local optimal allocation can be compared. If it is determined that there is not a previous determination of a local optimal allocation, then the method 600 proceeds to operation 655, where the current allocation is determined to be the best local optimal allocation. The method 600 then proceeds to operation 657, where a new allocation can be determined based on a random shake, randomly determining a new allocation of seats. This new allocation can then be used as the current allocation at operation 610.

If, at operation 650, it is determined that there is a previous determination of a local optimal allocation, then the method 600 proceeds to operation 660, where the best local optimal allocation is determined between the current most recent local optimal allocation and the previous local optimal allocation based on their respective distance costs. The allocation having the lower distance cost is determined to be the best local optimal allocation.

At operation 670, it is determined whether or not the optimization algorithm is complete. This determination can be based on one or more factors, including, but not limited to, whether a predetermined number of iterations of the algorithm has been performed or whether the execution time of the algorithm has exceeded a predetermined threshold amount of time. If it is determined that the optimization algorithm is complete, then the best local optimal allocation can be used as the final allocation, which can be determined by the allocation module 320 to be the allocation to apply for the event at issue. If it is determined that the optimization algorithm is not complete, then the method 600 proceeds to operation 657, where a new allocation can be determined based on a random shake, randomly determining a new allocation of seats. This new allocation can then be used as the current allocation at operation 610.

It is contemplated that any of the other features described within the present disclosure can be incorporated into method 600.

### Example Mobile Device

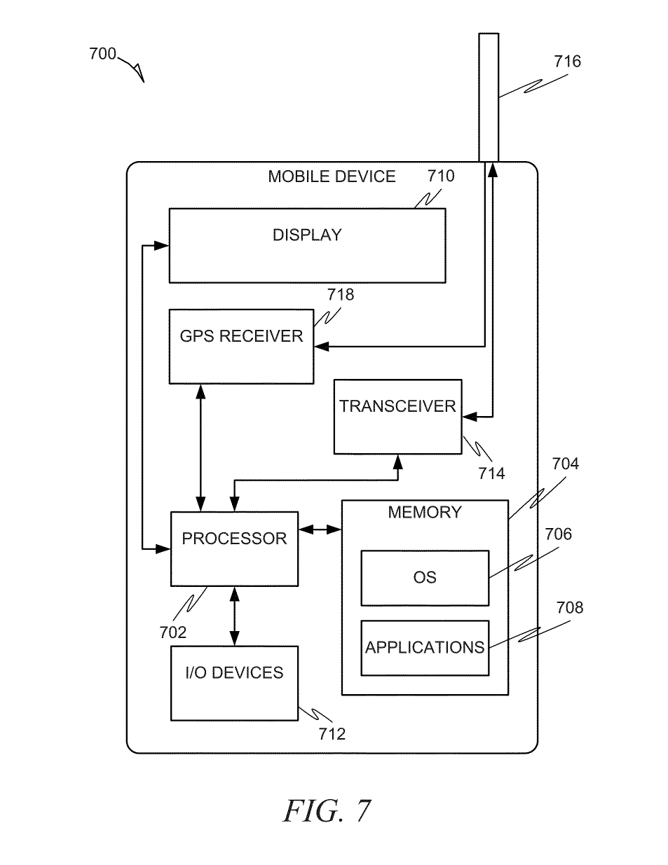

FIG. 7 is a block diagram illustrating a mobile device 700, according to some example embodiments. The mobile device 700 can include a processor 702. The processor 702 can be any of a variety of different types of commercially available processors suitable for mobile devices 700 (for example, an XScale architecture microprocessor, a Microprocessor without Interlocked Pipeline Stages (MIPS) architecture processor, or another type of processor). A memory 704, such as a random access memory (RAM), a Flash memory, or other type of memory, is typically accessible to the processor 702. The memory 704 can be adapted to store an operating system (OS) 706, as well as application programs 708, such as a mobile location enabled application that can provide LBSs to a user. The processor 702 can be coupled, either directly or via appropriate intermediary hardware, to a display 710 and to one or more input/output (I/O) devices 712, such as a keypad, a touch panel sensor, a microphone, and the like. Similarly, in some example embodiments, the processor 702 can be coupled to a transceiver 714 that interfaces with an antenna 716. The transceiver 714 can be configured to both transmit and receive cellular network signals, wireless data signals, or other types of signals via the antenna 716, depending on the nature of the mobile device 700. Further, in some configurations, a GPS receiver 718 can also make use of the antenna 716 to receive GPS signals.

### Modules, Components and Logic

Certain embodiments are described herein as including logic or a number of components, modules, or mechanisms. Modules can constitute either software modules (e.g., code embodied on a machine-readable medium or in a transmission signal) or hardware modules. A hardware module is a tangible unit capable of performing certain operations and can be configured or arranged in a certain manner. In example embodiments, one or more computer systems (e.g., a standalone, client, or server computer system) or one or more hardware modules of a computer system (e.g., a processor or a group of processors) can be configured by software (e.g., an application or application portion) as a hardware module that operates to perform certain operations as described herein.

In various embodiments, a hardware module can be implemented mechanically or electronically. For example, a hardware module can comprise dedicated circuitry or logic that is permanently configured (e.g., as a special-purpose processor, such as a field programmable gate array (FPGA) or an application-specific integrated circuit (ASIC)) to perform certain operations. A hardware module can also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) can be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor can be configured as respective different hardware modules at different times. Software can accordingly configure a processor, for example, to constitute a particular hardware module at one instance of time and to constitute a different hardware module at a different instance of time.

Hardware modules can provide information to, and receive information from, other hardware modules. Accordingly, the described hardware modules can be regarded as being communicatively coupled. Where multiple of such hardware modules exist contemporaneously, communications can be achieved through signal transmission (e.g., over appropriate circuits and buses) that connect the hardware modules. In embodiments in which multiple hardware modules are configured or instantiated at different times, communications between such hardware modules can be achieved, for example, through the storage and retrieval of information in memory structures to which the multiple hardware modules have access. For example, one hardware module can perform an operation and store the output of that operation in a memory device to which it is communicatively coupled. A further hardware module can then, at a later time, access the memory device to retrieve and process the stored output. Hardware modules can also initiate communications with input or output devices and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors can constitute processor-implemented modules that operate to perform one or more operations or functions. The modules referred to herein can, in some example embodiments, comprise processor-implemented modules.

Similarly, the methods described herein can be at least partially processor-implemented. For example, at least some of the operations of a method can be performed by one or more processors or processor-implemented modules. The performance of certain of the operations can be distributed among the one or more processors, not only residing within a single machine, but deployed across a number of machines. In some example embodiments, the processor or processors can be located in a single location (e.g., within a home environment, an office environment or as a server farm), while in other embodiments the processors can be distributed across a number of locations.

The one or more processors can also operate to support performance of the relevant operations in a “cloud computing” environment or as a “software as a service” (SaaS). For example, at least some of the operations can be performed by a group of computers (as examples of machines including processors), these operations being accessible via a network (e.g., the network 114 of FIG. 1) and via one or more appropriate interfaces (e.g., APIs).

Example embodiments can be implemented in digital electronic circuitry, or in computer hardware, firmware, software, or in combinations of them. Example embodiments can be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations can be performed by one or more programmable processors executing a computer program to perform functions by operating on input data and generating output. Method operations can also be performed by, and apparatus of example embodiments can be implemented as, special purpose logic circuitry (e.g., a FPGA or an ASIC).

A computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware can be a design choice. Below are set out hardware (e.g., machine) and software architectures that can be deployed, in various example embodiments.

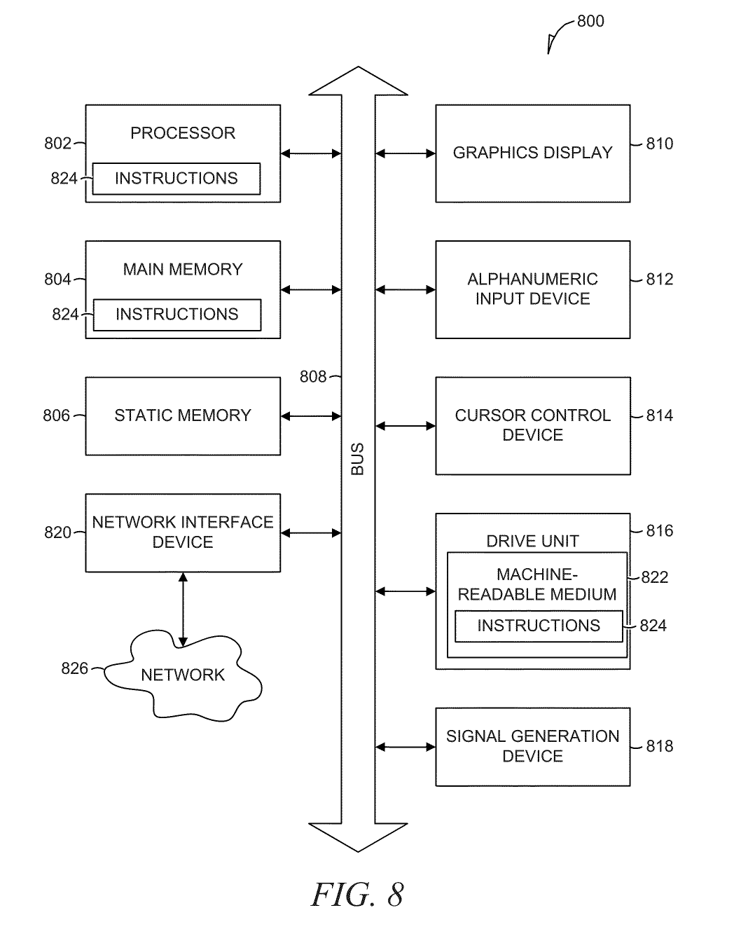

FIG. 8 is a block diagram of a machine in the example form of a computer system 800 within which instructions 824 for causing the machine to perform any one or more of the methodologies discussed herein can be executed, in accordance with some example embodiments. In alternative embodiments, the machine operates as a standalone device or can be connected (e.g., networked) to other machines. In a networked deployment, the machine can operate in the capacity of a server or a client machine in a server-client network environment, or as a peer machine in a peer-to-peer (or distributed) network environment. The machine can be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor 802 (e.g., a central processing unit (CPU), a graphics processing unit (GPU) or both), a main memory 804 and a static memory 806, which communicate with each other via a bus 808. The computer system 800 can further include a video display unit 810 (e.g., a liquid crystal display (LCD) or a cathode ray tube (CRT)). The computer system 800 also includes an alphanumeric input device 812 (e.g., a keyboard), a user interface (UI) navigation (or cursor control) device 814 (e.g., a mouse), a disk drive unit 816, a signal generation device 818 (e.g., a speaker) and a network interface device 820.

The disk drive unit 816 includes a machine-readable medium 822 on which is stored one or more sets of data structures and instructions 824 (e.g., software) embodying or utilized by any one or more of the methodologies or functions described herein. The instructions 824 can also reside, completely or at least partially, within the main memory 804 and/or within the processor 802 during execution thereof by the computer system 800, the main memory 804 and the processor 802 also constituting machine-readable media. The instructions 824 can also reside, completely or at least partially, within the static memory 806.

While the machine-readable medium 822 is shown in an example embodiment to be a single medium, the term “machine-readable medium” can include a single medium or multiple media (e.g., a centralized or distributed database, and/or associated caches and servers) that store the one or more instructions 824 or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and compact disc-read-only memory (CD-ROM) and digital versatile disc (or digital video disc) read-only memory (DVD-ROM) disks.

The instructions 824 can further be transmitted or received over a communications network 826 using a transmission medium. The instructions 824 can be transmitted using the network interface device 820 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium capable of storing, encoding, or carrying instructions for execution by the machine, and includes digital or analog communications signals or other intangible media to facilitate communication of such software.

Although an embodiment has been described with reference to specific example embodiments, it will be evident that various modifications and changes can be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter can be practiced. The embodiments illustrated are described in sufficient detail to enable those skilled in the art to practice the teachings disclosed herein. Other embodiments can be utilized and derived therefrom, such that structural and logical substitutions and changes can be made without departing from the scope of this disclosure. This Detailed Description, therefore, is not to be taken in a limiting sense, and the scope of various embodiments is defined only by the appended claims, along with the full range of equivalents to which such claims are entitled.

Although specific embodiments have been illustrated and described herein, it should be appreciated that any arrangement calculated to achieve the same purpose can be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A system comprising:
a booking module configured to:
receive, via a network, a plurality of organizer requests for an event from at least one device, each organizer request of the plurality of organizer requests corresponding to a different organizing-user and comprising a corresponding number of positions for the corresponding organizing-user and a corresponding identification for each one of at least one guest-user, the number of positions for each organizing-user representing the organizing-user and at least one guest of the organizing-user;
receive, from at least one device, a corresponding guest request for each one of the guest-users, each guest request comprising a corresponding number of positions for the event, the number of positions for each guest-user representing the guest-user and at least one guest of the guest-user; and
determine a plurality of groups based on the number of positions for the organizing-users and the number of positions for the guest-users, each group in the plurality of groups corresponding to a different one of the organizing-users and comprising a corresponding plurality of subgroups, each plurality of subgroups comprising a subgroup for the organizing-user and a corresponding subgroup for each guest-user corresponding to the organizing-user, the subgroup for the organizing-user comprising the organizing-user and the at least one guest of the organizing-user, the subgroup for each guest-user comprising the guest-user and the at least one guest of the guest-user; and
an allocation module, executable on at least one processor, configured to allocate positions for the event to the organizing-users and the guest-users based on their corresponding number of positions and an iterative optimization algorithm, the iterative optimization algorithm being configured to determine an allocation of positions for the event based on calculated distances between positions for each group.

2. The system of claim 1, wherein the positions comprise seats.

3. The system of claim 1, wherein the booking module is further configured to transmit a notification to each one of the guest-users, the notification comprising an identification of the event, and the notification being configured to enable the corresponding guest-user to submit the corresponding number of positions for the event.

4. The system of claim 3, wherein transmitting the notification to each one of the guest-users comprises at least one of transmitting an e-mail comprising the notification, transmitting a text message comprising the notification, and causing a page comprising the notification to be displayed within an application on a computing device.

5. The system of claim 1, wherein the booking module is further configured to:
determine that a predetermined time period for requesting positions has terminated, the plurality of organizer requests and the plurality of guest requests having been received within the predetermined time period; and
generate an interrupt based on the determining that the predetermined time period has terminated,
the allocation module being configured to allocate the positions for the event based on the generated interrupt.

6. The system of claim 1, wherein the iterative optimization algorithm is further configured to determine the allocation based on a preference to minimize a distance between subgroups of a same group.

7. The system of claim 1, wherein the iterative optimization algorithm is further configured to determine the allocation based on a preference to minimize a distance between members of a same subgroup, the members comprising any of the organizing-users, guest-users, and guests of the same subgroup.

8. The system of claim 1, wherein the iterative optimization algorithm is further configured to determine the allocation based on a preference to configure members of a same subgroup in a line configuration in a same row based on a first determination that the same subgroup satisfies a first predetermined condition for number of members, and to configure members of the same subgroup in a block configuration in different rows based on a second determination that the same subgroup satisfies a second predetermined condition for number of members, the members comprising any of the organizing-users, guest-users, and guests of the same subgroup.

9. The system of claim 1, wherein the iterative optimization algorithm comprises a Monte Carlo method.

10. The system of claim 1, wherein the iterative optimization algorithm comprises:
determining a current allocation of positions to members of each one of the plurality of groups for the event, the members comprising the organizing-users, guest-users, and guests of the plurality of groups;
determining if a potential change to the current allocation will reduce a distance cost of the current allocation, the potential change comprising switching a position allocation of two of the members;
in response to a determination that the potential change will reduce the distance cost, changing the current allocation based on the potential change;
in response to a determination that the potential change will not reduce the distance cost, determining a local optimal allocation to be the current allocation;
randomly determining a new allocation of positions to members of the each one of the plurality of groups for the event;
initializing the current allocation to be equal to the new allocation;
repeating the determining the current allocation, the determining if the potential change, the changing the current allocation, and the determining the local optimal allocation based on the initialized current allocation; and
determining a best local optimal allocation amongst multiple local optimal allocations based on a comparison of respective distance costs for the multiple local optimal allocations.

11. A computer-implemented method comprising:
receiving, via a network, a plurality of organizer requests for an event from at least one device, each organizer request of the plurality of organizer requests corresponding to a different organizing-user and comprising a corresponding number of positions for the corresponding organizing-user and a corresponding identification for each one of at least one guest-user, the number of positions for each organizing-user representing the organizing-user and at least one guest of the organizing-user;
transmitting a notification to each one of the guest-users, the notification comprising an identification of the event, and the notification being configured to enable the corresponding guest-user to submit a corresponding number of positions for the event;
receiving, from at least one device, a corresponding guest request for each one of the guest-users, each guest request comprising the corresponding number of positions for the event, the number of positions for each guest-user representing the guest-user and at least one guest of the guest-user;
determining a plurality of groups based on the number of positions for the organizing-users and the number of positions for the guest-users, each group in the plurality of groups corresponding to a different one of the organizing-users and comprising a corresponding plurality of subgroups, each plurality of subgroups comprising a subgroup for the organizing-user and a corresponding subgroup for each guest-user corresponding to the organizing-user, the subgroup for the organizing-user comprising the organizing-user and the at least one guest of the organizing-user, the subgroup for each guest-user comprising the guest-user and the at least one guest of the guest-user; and
allocating, by a machine having a memory and at least one processor, positions for the event to the organizing-users and the guest-users based on their corresponding number of positions and an iterative optimization algorithm, the iterative optimization algorithm being configured to determine an allocation of positions for the event based on calculated distances between positions for each group.

12. The method of claim 11, further comprising:
determining that a predetermined time period for requesting positions has terminated, the plurality of organizer requests and the plurality of guest requests having been received within the predetermined time period; and
generating an interrupt based on the determining that the predetermined time period has terminated, wherein the allocating is performed based on the generated interrupt.

13. The method of claim 11, wherein the iterative optimization algorithm is further configured to determine the allocation based on a preference to minimize a distance between subgroups of a same group.

14. The method of claim 11, wherein the iterative optimization algorithm is further configured to determine the allocation based on a preference to minimize a distance between members of a same subgroup, the members comprising any of the organizing-users, guest-users, and guests of the same subgroup.

15. The method of claim 11, wherein the iterative optimization algorithm is further configured to determine the allocation based on a preference to configure members of a same subgroup in a line configuration in a same row based on a first determination that the same subgroup satisfies a first predetermined condition for number of members, and to configure members of the same subgroup in a block configuration in different rows based on a second determination that the same subgroup satisfies a second predetermined condition for number of members, the members comprising any of the organizing-users, guest-users, and guests of the same subgroup.

16. The method of claim 11, wherein the iterative optimization algorithm comprises a Monte Carlo method.

17. The method of claim 11, wherein the iterative optimization algorithm comprises:
determining a current allocation of positions to members of each one of the plurality of groups for the event, the members comprising the organizing-users, guest-users, and guests of the plurality of groups;
determining if a potential change to the current allocation will reduce a distance cost of the current allocation, the potential change comprising switching a position allocation of two of the members;
in response to a determination that the potential change will reduce the distance cost, changing the current allocation based on the potential change;
in response to a determination that the potential change will not reduce the distance cost, determining a local optimal allocation to be the current allocation;
randomly determining a new allocation of positions to members of the each one of the plurality of groups for the event;
initializing the current allocation to be equal to the new allocation;
repeating the determining the current allocation, the determining if the potential change, the changing the current allocation, and the determining the local optimal allocation based on the initialized current allocation; and
determining a best local optimal allocation amongst multiple local optimal allocations based on a comparison of respective distance costs for the multiple local optimal allocations.

18. The method of claim 11, wherein transmitting the notification to each one of the guest-users comprises at least one of transmitting an e-mail comprising the notification, transmitting a text message comprising the notification, and causing a page comprising the notification to be displayed within an application on a computing device.

19. A non-transitory machine-readable storage medium, tangibly embodying a set of instructions that, when executed by at least one processor, causes the at least one processor to perform operations comprising:
receiving, via a network, a plurality of organizer requests for an event from at least one device, each organizer request of the plurality of organizer requests corresponding to a different organizing-user and comprising a corresponding number of positions for the corresponding organizing-user and a corresponding identification for each one of at least one guest-user, the number of positions for each organizing-user representing the organizing-user and at least one guest of the organizing-user;
transmitting a notification to each one of the guest-users, the notification comprising an identification of the event, and the notification being configured to enable the corresponding guest-user to submit a corresponding number of positions for the event;
receiving, from at least one device, a corresponding guest request for each one of the guest-users, each guest request comprising the corresponding number of positions for the event, the number of positions for each guest-user representing the guest-user and at least one guest of the guest-user;
determining a plurality of groups based on the number of positions for the organizing-users and the number of positions for the guest-users, each group in the plurality of groups corresponding to a different one of the organizing-users and comprising a corresponding plurality of subgroups, each plurality of subgroups comprising a subgroup for the organizing-user and a corresponding subgroup for each guest-user corresponding to the organizing-user, the subgroup for the organizing-user comprising the organizing-user and the at least one guest of the organizing-user, the subgroup for each guest-user comprising the guest-user and the at least one guest of the guest-user; and
allocating positions for the event to the organizing-users and the guest-users based on their corresponding number of positions and an iterative optimization algorithm, the iterative optimization algorithm being configured to determine an allocation of positions for the event based on calculated distances between positions for each group.

20. The storage medium of claim 19, wherein the operations further comprise:
determining that a predetermined time period for requesting positions has terminated, the plurality of organizer requests and the plurality of guest requests having been received within the predetermined time period; and
generating an interrupt based on the determining that the predetermined time period has terminated, wherein the allocating is performed based on the generated interrupt.
